(19) United States
(12) Patent Application Publication
(10) Pub. No.: US 2006/0092338 A1
(43) Pub. Date: May 4, 2006

(54) Projection display system having selective light projecting device

(75) Inventors: Hiroshi Sakai, Sagamihara-shi (JP); Kensuke Ishii, Tokyo (JP); Kazuya Yamanaka, Tokyo (JP); Susumu Kobayashi, Sayama-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 11/258,796

(22) Filed: Oct. 26, 2005

(30) Foreign Application Priority Data
Nov. 2, 2004 (JP) 2004-319038

(51) Int. Cl. H04N 9/31

(52) U.S. Cl. 348/744

(57) ABSTRACT

A projection display system includes a projector; a reflection screen for displaying images in a front projection system; a transmission screen for displaying images in a rear projection system; and a selective light projecting device for selectively directing the light from the projector to one of the reflection screen and the transmission screen, so as to perform switching between the front projection system and the rear projection system. The selective light projecting device may selectively change an optical path of image light from the projector between the reflection screen and the transmission screen, so as to direct the image light to one of the reflection screen and the transmission screen, or may selectively rotates a direction of a head of the projector between the reflection screen and the transmission screen, so as to emit the image light to one of the reflection screen and the transmission screen.

### BACKGROUND OF THE INVENTION

1. Field of the Invention

The present invention relates to a projection display system which can selectively display images on a reflection screen or a transmission screen.

Priority is claimed on Japanese Patent Application No. 2004-319038, filed Nov. 2, 2004, the content of which is incorporated herein by reference.

2. Description of the Related Art

Projection display systems for projecting images (or pictures) generated via a liquid crystal panel are classified into a front projection system in which projection is performed from a front side of a reflection screen, and a rear projection system in which projection is performed from a rear side of a transmission screen. The front projection system is suitable for displaying impressive images such as movies on a big-sized screen. However, it is necessary to darken the surroundings so as to project distinct images; thus, it is difficult to easily enjoy image reproduction. In contrast, in the rear projection system, it is difficult to project big-sized images; however, distinct images can be projected without darkening the surroundings. Therefore, the rear projection system is suitable for showing news or variety programs.

As described above, the front and the rear projection systems each have their respective advantageous characteristics. That is, the front projection system is more preferable for projecting big-sized, impressive images such as movies, while the rear projection system is more preferable for easily enjoying news or variety programs.

Accordingly, a single projection display system by which both the front and the rear projection systems can be used is desired.

Reference 1 (Japanese Unexamined Patent Application, First Publication No. H04-366936) and reference 2 (Japanese Unexamined Patent Application, First Publication No. 2001-094905) show examples of a single projection display system by which both the front and the rear projection systems can be used.

In the system disclosed in Reference 1, an optical path is changed by rotating a mirror, so as to switch the projection system between the front projection and the rear projection. In the system disclosed in Reference 2, images of the front projection system and the rear projection system can be simultaneously shown by using a half mirror.

In the projection display system of Reference 1, the front projection system and the rear projection system can be selectively switched to each other. In this projection display system, images projected by the front projection system and the rear projection system respectively face the opposite directions. Therefore, when the projection system is switched from the front projection to the rear projection, an audience must turn round or the projection display system itself must be turned.

In the projection display system of Reference 2, images of the front projection system and the rear projection system are simultaneously shown; however, the front and rear projection systems cannot be selectively switched.

### SUMMARY OF THE INVENTION

The present invention provides a projection display system comprising:

a projector for projecting image light;

a reflection screen for displaying images in a front projection system, wherein the light from the projector is emitted to a front face of the reflection screen;

a transmission screen for displaying images in a rear projection system, wherein the light from the projector is emitted to a back face of the reflection screen; and

a selective light projecting device for selectively directing the light from the projector to one of the reflection screen and the transmission screen, so as to perform switching between the front projection system and the rear projection system.

In a typical example, the selective light projecting device selectively changes an optical path of the light from the projector between the reflection screen and the transmission screen, so as to direct the light from the projector to one of the reflection screen and the transmission screen.

In another typical example, the selective light projecting device selectively rotates a direction of a head of the projector between the reflection screen and the transmission screen, so as to emit the light from the projector to one of the reflection screen and the transmission screen.

The reflection screen may be attached as an integral part of a main body of the projection display system, or may be separate from a main body of the projection display system.

Typically, the reflection screen is bigger than the transmission screen.

Preferably, the switching between the front projection system and the rear projection system is performed using a remote control.

Typically, when the rear projection system is selected, a control for exposing the transmission screen is performed, and when the front projection system is selected, a control for exposing the reflection screen is performed.

Preferably, parameters for focus and zoom of the projector are adjusted in accordance with whether the rear projection system or the front projection system is selected.

In a possible example, adjusted values of the parameters for focus and zoom are determined and stored before shipment of the projection display system, and after that the parameters can be freely adjusted and stored.

Preferably, an aspect ratio is switched in accordance with whether the rear projection system or the front projection system is selected.

In an example, the aspect ratio is set to 4:3 in the rear projection system, and set to 16:9 in the front projection system.

In a possible example, each aspect ratio is determined and stored before shipment of the projection display system, and after that the aspect ratio can be freely adjusted and stored.

Preferably, a light output of the projector is adjusted in accordance with whether the rear projection system or the front projection system is selected.

In a possible example, adjusted values of each light output are determined and stored before shipment of the projection display system, and after that the light output can be freely adjusted and stored.

In a typical example, the adjustment of the light output is performed by selectively using any of lamps having different light outputs.

In another typical example, the adjustment of the light output is performed by switching a light output of a single lamp.

In another typical example, the adjustment of the light output is performed by mixing light beams from a plurality of lamps.

Preferably, parameters for color and brightness of the projector are adjusted in accordance with whether the rear projection system or the front projection system is selected.

In a possible example, adjusted values of the parameters for color and brightness are determined and stored before shipment of the projection display system, and after that the parameters can be freely adjusted and stored.

### BRIEF DESCRIPTION OF THE DRAWINGS

FIGS. 1A and 1B show the general structure of a projection display system as a first embodiment of the present invention.

FIGS. 2A and 2B are diagrams for explaining switching of the optical path in the projection display system of the first embodiment.

FIGS. 3A and 3B are sectional views showing the internal structure of the optical path in the projection display system of the first embodiment.

FIGS. 4A and 4B are top sectional views for explaining a mechanism for controlling mirrors in the projection display system of the first embodiment.

FIG. 5 is a block diagram showing the structure of the projection display system of the first embodiment.

FIGS. 6A and 6B are top views showing an opening and closing mechanism for a light emission aperture in the projection display system of the first embodiment.

FIGS. 7A and 7B show a mechanism for drawing and retracting a reflection screen in the projection display system of the first embodiment.

FIG. 8 is a perspective view showing another example of the reflection screen in the projection display system of the first embodiment.

FIG. 9 is a diagram for explaining a focus and zoom adjusting mechanism in the projection display system of the first embodiment.

FIG. 10 is a perspective view showing an example of a mechanism for switching the light source of the projector in the projection display system of the first embodiment.

FIG. 11 is a diagram for explaining another example of the mechanism for switching the light source of the projector in the projection display system of the first embodiment.

FIGS. 12A and 12B are diagrams for explaining rotation of the projector in a projection display system as a second embodiment of the present invention.

FIGS. 13A and 13B show the general structure of a projection display system as a third embodiment of the present invention.

### DESCRIPTION OF THE PREFERRED EMBODIMENTS

Hereinafter, embodiments according to the present invention will be described with reference to the appended figures.

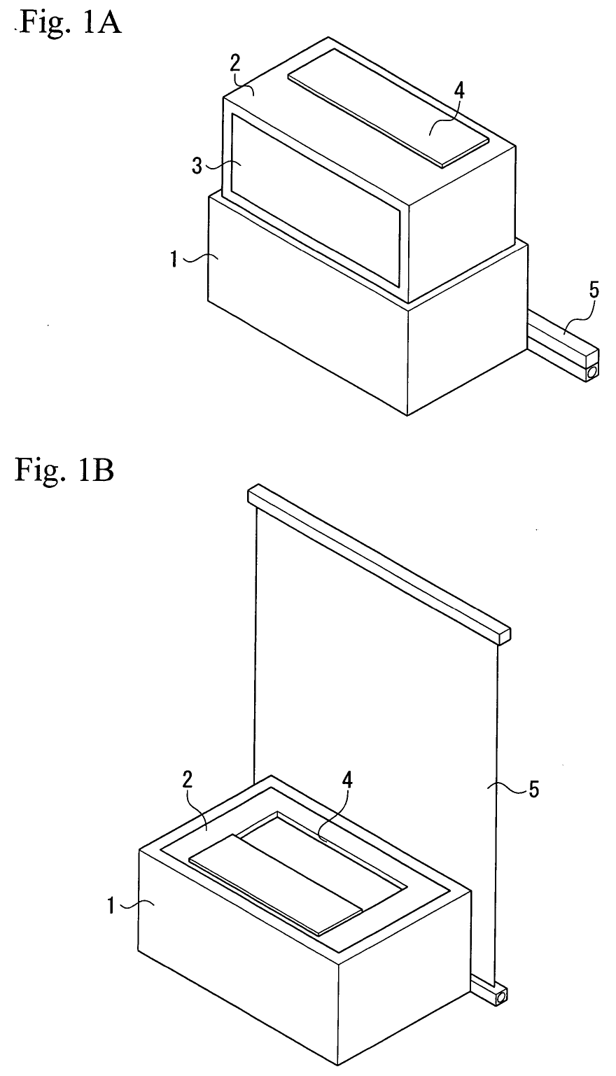

In a projection display system to which the present invention is applied, the front projection system and the rear projection system can be selectively switched. FIGS. 1A and 1B show a first embodiment of the present invention. FIG. 1A shows a state when the rear projection system is selected, and FIG. 1B shows a state when the front projection system is selected.

In FIGS. 1A and 1B, on an upper face side of a box body 1, a box body 2 is provided, which can be freely raised or lowered. A transmission screen 3 is attached to the box body 2. The upper face of the box body 2 has a light emission aperture 4 which can be freely opened or closed. To the back side of the box body 1, a reflection screen 5 is attached, which is capable of being drawn upward and lowered. In the example shown, the reflection screen 5 is an integral part of the projection display system.

The transmission screen 3 shows images by receiving light projected from the back when the rear projection system is selected. The reflection screen 5 shows images by receiving light projected from the front when the front projection system is selected. In order that movies or the like can be enjoyed with a big-sized, impressive picture screen, the reflection screen 5 is bigger than the transmission screen 3. For example, the transmission screen 3 is a 25-inch screen, and the reflection screen 5 is an 80-inch screen.

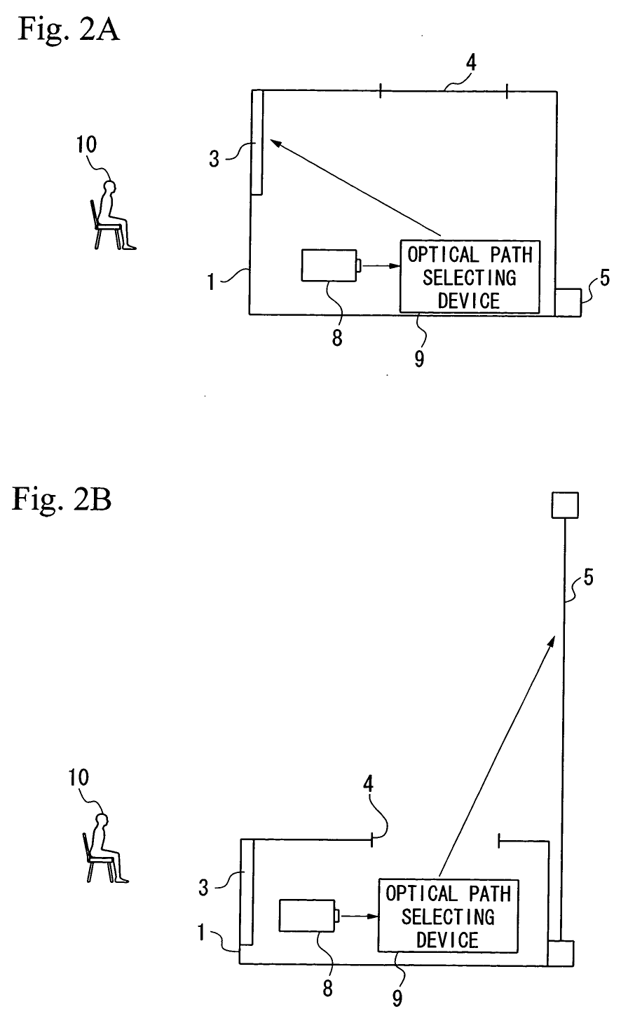

As shown in FIGS. 2A and 2B, in the box body 1, a projector 8 and an optical path selecting device 9 are provided. The optical path from the projector 8 can be selectively switched by the optical path selecting device 9 in accordance with the selection between the rear projection system (see FIG. 2A) and the front projection system (FIG. 2B).

In the rear projection system, as shown in FIG. 1A, the box body 2 is moved upward so that the transmission screen 3 is exposed, the reflection screen 5 is contained, and the light emitting aperture 4 is closed. Additionally, as shown in FIG. 2A, the optical path is selected by the optical path selecting device 9 so that light from the projector 8 is directed to the transmission screen 3. Accordingly, as shown in FIG. 2A, light from the projector 8 is projected via the optical path selecting device 9 onto the back face of the transmission screen 3, thereby projecting images to the transmission screen 3.

When the projection system is switched to the front projection system, as shown in FIG. 1B, the box body 2 is lowered, the transmission screen 3 is contained, the reflection screen 5 is drawn upward, and the light emitting aperture 4 is opened. Additionally, as shown in FIG. 2B, the optical path is selected by the optical path selecting device 9 so that light from the projector 8 is emitted from the light emitting aperture 4 toward the reflection screen 5. Accordingly, as shown in FIG. 2B, light from the projector 8 is projected via the optical path selecting device 9 and the light emitting aperture 4 onto the front face of the reflection screen 5, thereby projecting images to the reflection screen 5.

As described above, in the projection display system of the first embodiment of the present invention, the rear projection system and the front projection system can be selectively switched to each other. Accordingly, when enjoying movies or the like, the front projection system may be selected so as to enjoy impressive images on a big-sized screen. On the other hand, when enjoying news or variety programs, the rear projection system may be selected so as to easily enjoy the programs without darkening the surroundings.

In addition, in the projection display system of the first embodiment of the present invention, the optical path selecting device 9 is provided between the transmission screen 3 and the reflection screen 5. When the rear projection system is selected, the optical path is set toward a front and upper direction so that light is directed to the transmission screen 3, and when the front projection system is selected, the optical path is set toward a rear and upper direction so that light is directed to the reflection screen 5. Accordingly, when the optical path selecting device 9 is provided between the transmission screen 3 and the reflection screen 5, either images projected onto the transmission screen 3 in the rear projection system and images projected onto the reflection screen 5 in the front projection system can be viewed from the same direction by an audience 10. Therefore, as shown in FIGS. 2A and 2B, the audience 10 can enjoy images at the same position in either the rear projection system and the front projection system, and it is unnecessary for the audience 10 to turn round, or unnecessary to change the position of the projection display system.

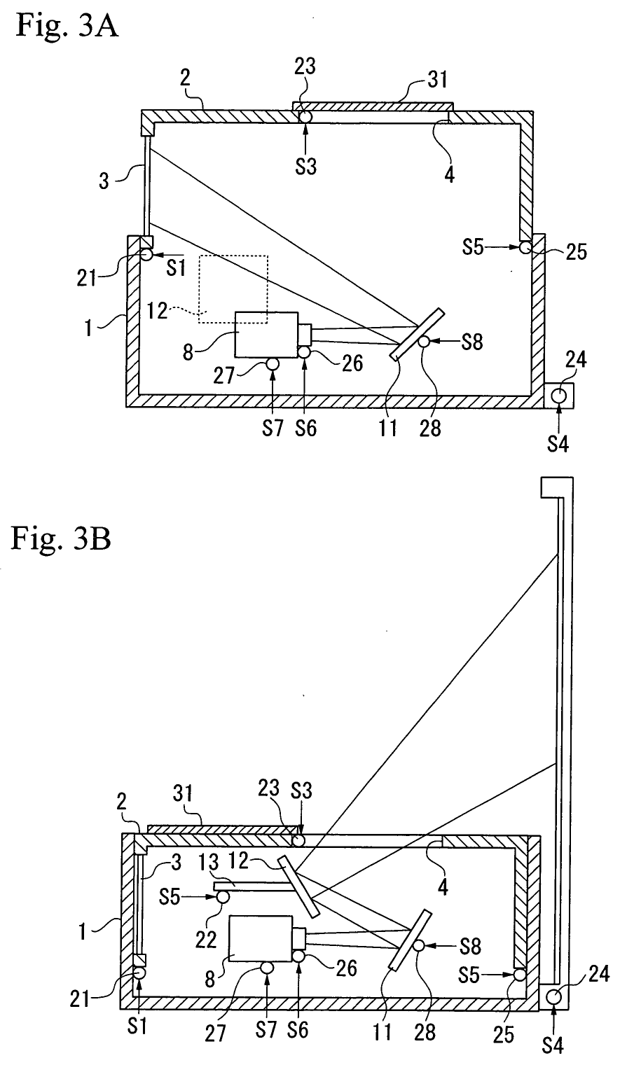

Below, the projection display system of the first embodiment will be explained in more detail. FIGS. 3A and 3B show detailed structures inside the box body 1 of the projection display system of the first embodiment. FIG. 3A shows a state when the rear projection system is selected, and FIG. 3B shows a state when the front projection system is selected.

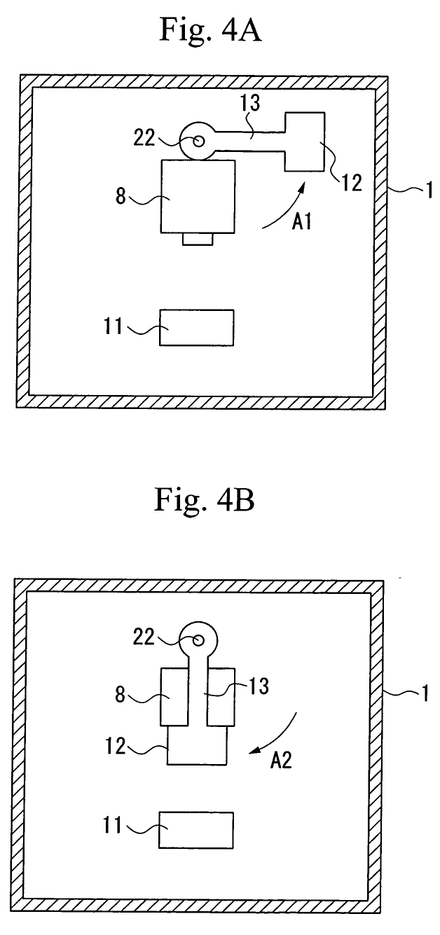

As shown in the FIGS. 3A and 3B, the box body 1 contains the projector 8 and mirrors 11 and 12. The mirrors 11 and 12 correspond to the optical path selecting device 9 in FIGS. 2A and 2B. As shown in FIGS. 4A and 4B, the mirror 12 is attached to a mirror control board 13 which can be freely rotated.

In FIGS. 3A and 3B, the box body 1 also contains transmission screen moving motors 21 and 25 for vertically moving the transmission screen 3 by vertically moving the box body 2, a mirror control motor 22 (see FIG. 3B) for moving the mirror 12 by rotating the mirror control board 13, an opening and closing motor 23 for opening and closing the light emitting aperture 4, and a reflection screen moving motor 24 for drawing and retracting the reflection screen 5.

The box body 1 also contains a focus and zoom adjusting motor 26 for adjusting focus and zoom (functions) of the projector 8, a light source switching motor 27 for switching the light source of the projector 8, and a mirror adjusting motor 28 for adjusting the angle of the mirror 11.

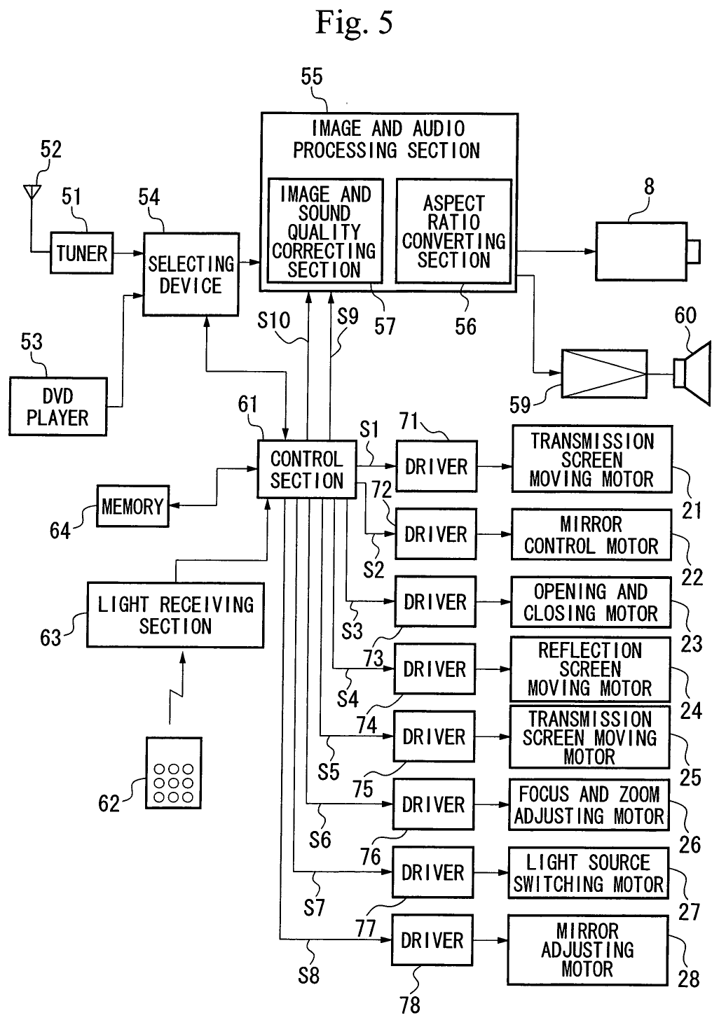

FIG. 5 is a block diagram showing the structure of the projection display system of the first embodiment of the present invention. In FIG. 5, a tuner 51 selects a signal (desired by the audience) from among television signals received by an antenna 52 and decodes the selected television signal, thereby outputting image and audio signals. The signals output from the tuner 51 are supplied to a selecting device 54.

A DVD (digital versatile disk) player 53 reads signals stored in a mounted DVD disk and decodes reproduction signals, thereby outputting image and audio signals. The signals output from the DVD player 53 are supplied to the selecting device 54.

The selecting device 54 is a source switching switch. Signals output from the selecting device 54 are sent to an image and audio processing section 55. In an image and sound quality correcting section 57 of the image and audio processing section 55, image and audio signals are subjected to signal processing for controlling quality of images and sounds, and the like. The image and audio processing section 55 also includes an aspect ratio converting section 56 for converting an aspect ratio of the screen from 4:3 to 16:9, or from 16:9 to 4:3.

Image signals from the image and audio processing section 55 are sent to the projector 8, from which image light (i.e., optical signals) corresponding to the input image signals is output. In addition, audio signals from the image and audio processing section 55 are sent to an amplifier 59 and then output from a speaker 60.

The tuner 51 and the DVD player 53 may be built in the box body 1 or be external devices of the projection display system. In addition, only the tuner 51 may be built in the box body 1 and the DVD player 53 may be connected to the system as an external device via an interface. Other imaging devices such as a VTR (video tape recorder) may function as a source instead of the tuner 51 and the DVD player 53. The speaker 60 may part of the projection display system or be separate from the system.

A control section 61 controls the whole system. To the control section 61, a command signal is sent via a light receiving section 63 from an infrared remote control 62 operated by an audience (i.e., a user). Due to the command signal from the infrared remote control 62, switching of channels and sources, audio volume setting, and switching between the rear projection system and the front projection system can be performed.

When switching between the rear projection system and the front projection system is performed by operating the infrared remote control 62, the control section 61 outputs control signals S1 and S5 for raising and lowering the transmission screen 3, a control signal S2 for moving the mirror 12, a control signal S3 for opening and closing the light emission aperture 4, a control signal S4 for vertically moving (i.e., drawing and retracting) the reflection screen 5, a control signal S6 for performing focus and zoom adjustment, a control signal S7 for switching the light source, a control signal S8 for adjusting the angle of the mirror 11, a control signal S9 for switching the aspect ratio, and a control signal S10 for controlling quality of images (relating to colors and brightness) and sound quality.

The control signals S1 and S5 are supplied via drivers 71 and 75 to the transmission screen moving motors 21 and 25. The control signal S2 is supplied via a driver 72 to the mirror control motor 22. The control signal S3 is supplied via a driver 73 to the opening and closing motor 23.

The control signal S4 is supplied via a driver 74 to the reflection screen moving motor 24. The control signal S6 is supplied via a driver 76 to the focus and zoom adjusting motor 26. The control signal S7 is supplied via a driver 77 to the light source switching motor 27. The control signal S8 is supplied via a driver 78 to the mirror adjusting motor 28.

The control signals S9 and S10 are supplied to the image and audio processing section 55.

In a memory 64, various adjustment data are stored in advance before the projection display system is shipped from a manufacturing factory. The data are optimum values for each setting of the rear and the front projection systems, relating to focus and zoom adjustment, adjustment of quality of images (specifically, colors and brightness) and sound quality, the aspect ratio, and the like.

When the user operates the infrared remote control 62 so as to select the rear projection system or the front projection system, a command signal is output from the infrared remote control 62 via the light receiving section 63 to the control section 61. In accordance with the setting of the projection system between the rear projection and the front projection, the control section 61 appropriately outputs the control signals S1 to S10. Accordingly, the motors 21 to 27 and the image and audio processing section 55 are controlled, thereby performing setting for the rear projection system or the front projection system.

That is, as shown in FIGS. 3A and 3B, the box body 1 contains, the transmission screen moving motors 21 and 25 for vertically moving the transmission screen 3 attached to the box body 2 based on the control signals S1 and S5, the mirror control motor 22 for moving the mirror 12 by rotating the mirror control board 13 based on the control signal S2, the opening and closing motor 23 for opening and closing the light emission aperture 4 based on the control signal S3, and the reflection screen moving motor 24 for drawing and retracting the reflection screen 5 based on the control signal S4.

When the rear projection system is selected, as shown in FIG. 3A, the box body 2 is moved upward so as to expose the transmission screen 3 by using the transmission screen moving motors 21 and 25. In addition, as shown in FIG. 4A, the mirror control board 13 is rotated in a direction indicated by the arrow A1 so that the mirror 12 is out of the optical path, by using the mirror control motor 22. Additionally, the light emission aperture 4 is closed by the opening and closing motor 23, and the reflection screen 5 is retracted by the reflection screen moving motor 24. Accordingly, as shown in FIG. 3A, light from the projector 8 is reflected by the mirror 11 and projected onto the transmission screen 3.

Conversely, when the front projection system is selected, as shown in FIG. 3B, the transmission screen 3 is contained by using the transmission screen moving motors 21 and 25, and as shown in FIG. 4B, the mirror control board 13 is rotated in a direction indicated by the arrow A2 so that light from the mirror 11 is reflected by the mirror 12. In addition, the light emission aperture 4 is opened by the opening and closing motor 23, and the reflection screen 5 is drawn upward by the reflection screen moving motor 24. Accordingly, as shown in FIG. 3B, light from the projector 8 is reflected by the mirror 11 and further reflected by the mirror 12, so that the light is projected onto the reflection screen 5.

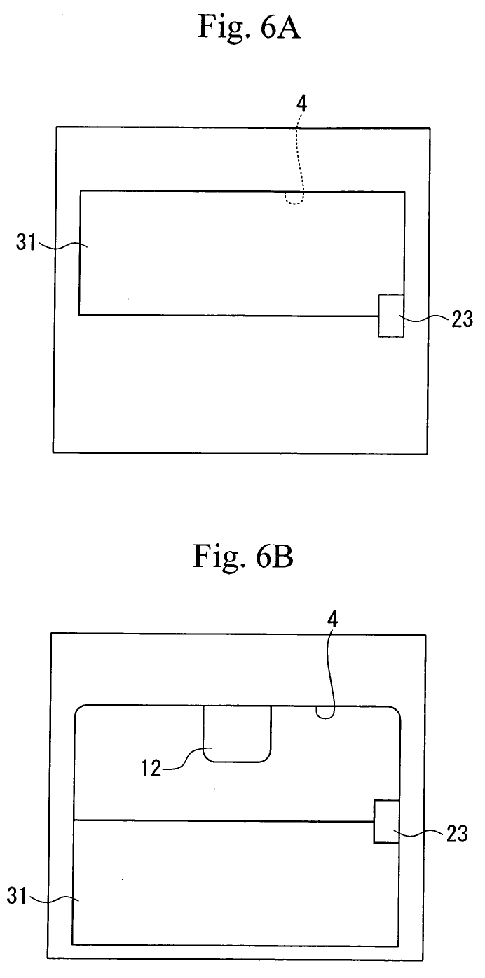

FIGS. 6A and 6B are top views showing an opening and closing mechanism for the light emission aperture 4. As shown in FIGS. 6A and 6B, a cover 31 for covering the light emission aperture 4 is provided. The cover 31 can be freely opened and closed by the opening and closing motor 23.

When the rear projection system is selected, as shown in FIG. 6A, the cover 31 is closed by the opening and closing motor 23, so that the light emission aperture 4 is closed by the cover 31, thereby preventing leaking of light. When the front projection system is selected, as shown in FIG. 6B, the cover 31 is opened by the opening and closing motor 23, so that the light emission aperture 4 is open and light is emitted from the light emission aperture 4 to the reflection screen 5.

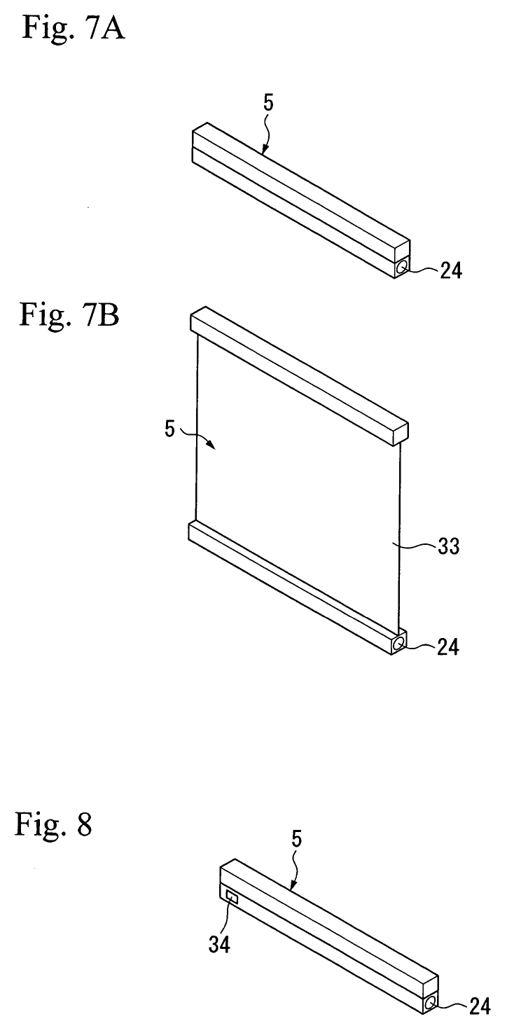

FIGS. 7A and 7B show a mechanism for drawing and retracting the reflection screen 5. The reflection screen 5 is contained by rolling up a screen portion 33 and the reflection screen moving motor 24 is used to draw the reflection screen 5 upward. When the rear projection system is selected, as shown in FIG. 7A, the reflection screen 5 is contained by rolling up the screen portion 33 around a roller 32. When the front projection system is selected, as shown in FIG. 7B, the screen portion 33 is drawn upward by the reflection screen moving motor 24.

As shown in FIG. 8, a light receiving section 34 may be provided in the screen portion for receiving a control signal sent by infrared light from the main body of the projection display system, and the reflection screen 5 may be directly controlled by an infrared control signal from the infrared remote control 62.

In the present embodiment, the reflection screen 5 is an integral part of the projection display system. In this case, various kinds of adjustment data (for the screen) determined before the shipment of the projection display system can be used.

In addition, as shown in FIGS. 3A and 3B, the projection display system has the focus and zoom adjusting motor 26 for adjusting focus and zoom (functions) of the projector 8, the light source switching motor 27 for switching the light source of the projector 8, and the mirror adjusting motor 28 for adjusting the angle of the mirror 11. According to the selected projection system from among the rear projection and the front projection, (i) focus and zoom are adjusted using the focus and zoom adjusting motor 26, (ii) the light source of the projector 8 is switched using the light source switching motor 27, and (iii) the angle of the mirror 11 is adjusted using the mirror adjusting motor 28.

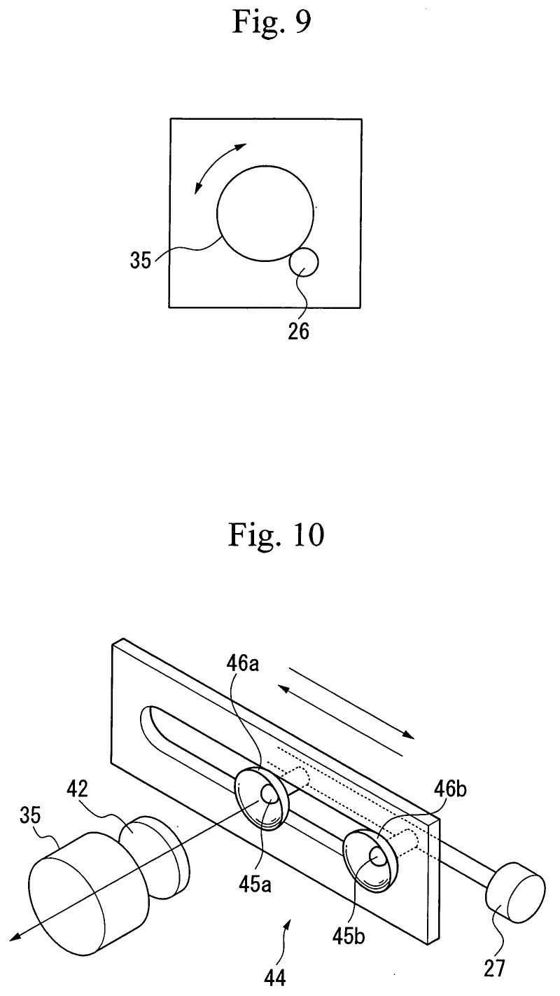

FIG. 9 shows a focus and zoom adjusting mechanism. The length of the optical path is different between the rear projection system and the front projection system; thus, there are also differences respectively in focus and zoom between the rear and the front projection systems. Therefore, when the rear projection system or the front projection system is selected (i.e., the projection system is switched), it is necessary to perform focus and zoom adjustment again. The focus and zoom adjusting mechanism shown in FIG. 9 is used to perform the focus and zoom adjustment again. In FIG. 9, the mechanism includes the focus and zoom adjusting motor 26 for adjusting focus and zoom of an imaging optical system 35. According to the selected projection system from among the rear projection and the front projection, the focus and zoom adjusting motor 26 is appropriately rotated, thereby obtaining optimum focus and zoom values (or quantities).

The optimum adjustment values for focus and zoom for each of the rear projection system and the front projection system are determined before the projection display system is shipped from the factory, and are stored in the memory 64 or the like. The user can freely adjust the focus and zoom values by operating the infrared remote control 62 and store the adjusted values.

FIG. 10 shows a mechanism for switching the light source provided in the projector 8. The screen size is different between the rear projection system and the front projection system; thus, brightness is also different between the two systems. In addition, in the front projection system, outside light should also be considered. Therefore, when the front projection system is selected, it is preferable to switch the light source of the projector 8, so as to increase the brightness, in comparison with the rear projection system.

In FIG. 10, a lighting system 44 includes two light sources 45a and 45b, two reflection umbrellas 46a and 46b, and the light source switching motor 27. The light source 45b has a larger light output than that of the light source 45a. When the rear projection system is selected, the light source 45a is selected. When the front projection system is selected, the light sources 45a and 45b are moved using the light source switching motor 27, so that the light source 45b having a larger light output is selected. FIG. 10 also shows the imaging optical system 35, and reference numeral 42 indicates a spatial modulation device.

In the example shown in FIG. 10, the above-described two light sources 45a and 45b having different light outputs are moved so as to switch the light source. However, a single light source 45 may be used. In this case, the light output is switched by switching the voltage applied to the light source 45.

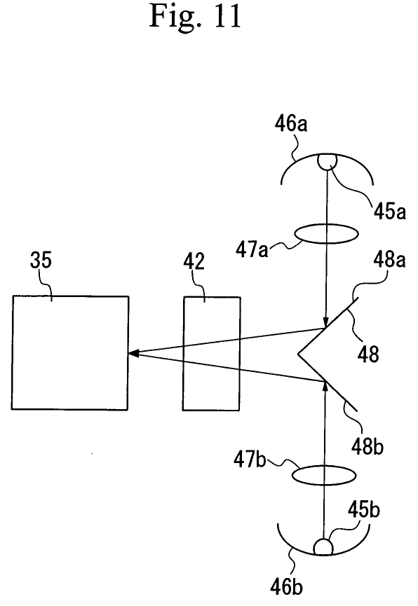

Additionally, in the example shown in FIG. 10, the light sources 45a and 45b having different light output are moved using a motor so as to switch the light source. However, as shown in FIG. 11, light beams from the light sources 45a and 45b may be respectively converged using lenses 47a and 47b, so as to respectively reflect the light beams by mirror surfaces 48a and 48b of a mirror 48. In this structure, the light output can be switched by switching a lighting state. For example, when the rear projection system is selected, only one of the light sources 45a and 45b is turned on, and when the front projection system is selected, both the light sources 45a and 45b are turned on so that light from the light source 45a and light from the light source 46b are combined. In this arrangement, each light source may have the same light output, and it is possible to obtain a spare light source which can be used when the life of either light source is completed.

Optimum values for the light output for each of the rear and the front projection systems are determined before the projection display system is shipped from the factory, and the determined values are stored in the memory 64 or the like. In addition, the user can adjust the light output by operating the infrared remote control 62 and store the adjusted output value.

According to the selected projection system between the rear projection and the front projection, values for image and sound adjustments are respectively switched using the image and sound quality correcting section 57. That is, in the rear projection system, parameters for adjusting color and brightness which are optimum for showing news or the like are selected, and in the front projection system, parameters for adjusting color and brightness which are optimum for showing movies or the like are selected. In addition, in the rear projection system, parameters for adjusting sound quality and surround sound which are optimum for showing news or the like are selected, and in the front projection system, parameters for adjusting sound quality and surround sound which are optimum for showing movies or the like are selected.

The optimum adjustment values for image and sound quality for each of the rear projection system and the front projection system are determined before the projection display system is shipped from the factory, and are stored in the memory 64 or the like. The user can freely adjust the values for image and sound quality by operating the infrared remote control 62 and store the adjusted values.

In addition, in the rear projection system, an aspect ratio of 4:3 may be selected. When the front projection system is selected, conversion of the aspect ratio from 4:3 to 16:9 is performed by the aspect ratio converting section 56 of the image and audio processing section 55. That is, when big-sized, impressive images, such as movies, are projected in the front projection system, an aspect ratio of 16:9 is selected. Conversely, when news or variety programs are projected in the rear projection system, an aspect ratio of 4:3 is selected.

The aspect ratios for each of the rear projection system and the front projection system are determined before the projection display system is shipped from the factory, and are stored in the memory 64 or the like. The user can freely adjust each aspect ratio by operating the infrared remote control 62 and store the adjusted value.

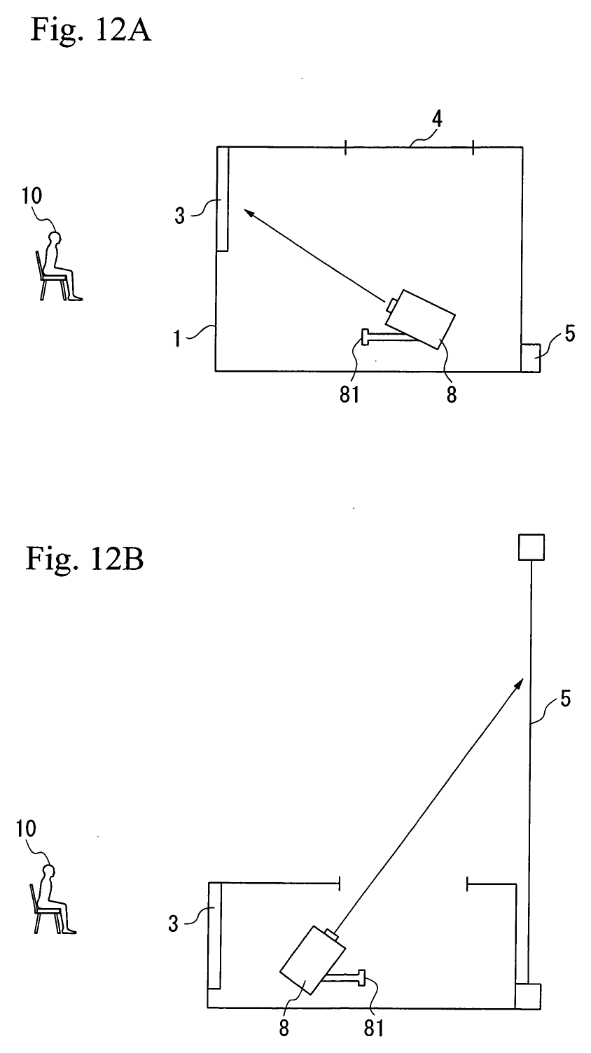

FIGS. 12A and 12B show a second embodiment of the present invention. In the above-described first embodiment, the optical path selecting device 9 is provided between the transmission screen 3 and the reflection screen 5, and one of the rear and the front projection systems is selected by switching the optical path to that having the opposite direction by using the optical path selecting device 9. In contrast, in the present embodiment, as shown in the FIGS. 12A and 12B, a light emitting direction of the projector 8, which is also positioned between the transmission screen 3 and the reflection screen 5, is rotated in accordance with the selected projection system among the rear projection and the front projection systems. Other portions in the structure are similar to those of the first embodiment.

As shown in FIG. 12A, the projector 8 is disposed between the transmission screen 3 and the reflection screen 5, and the projector 8 is rotated by a projector rotating mechanism 81 in accordance with the selected projection system among the rear projection and the front projection systems. In the arrangement for the rear projection system, the head of the projector 8 is turned front and upward, and accordingly, as shown in FIG. 12A, light from the projector 8 is projected to the back face of the transmission screen 3, so that images are shown on the transmission screen 3.

When the projection system is switched to the front projection, as shown in FIG. 12B, the projector 8 is rotated so that the head of the projector 8 faces back and upward, and light from the projector 8 is projected via the light emission aperture 4 to the front face of the reflection screen 5, so that images are shown on the reflection screen 5.

As explained above, when the switching between the rear projection system and the front projection system is performed by rotating the projector 8, either images projected onto the transmission screen 3 in the rear projection system and images projected onto the reflection screen 5 in the front projection system can be viewed from the same direction by an audience 10. Therefore, as shown in FIGS. 12A and 12B, the audience 10 can enjoy images at the same position in either the rear projection system and the front projection system, and it is unnecessary for the audience 10 to turn round, or unnecessary to change the position of the projection display system.

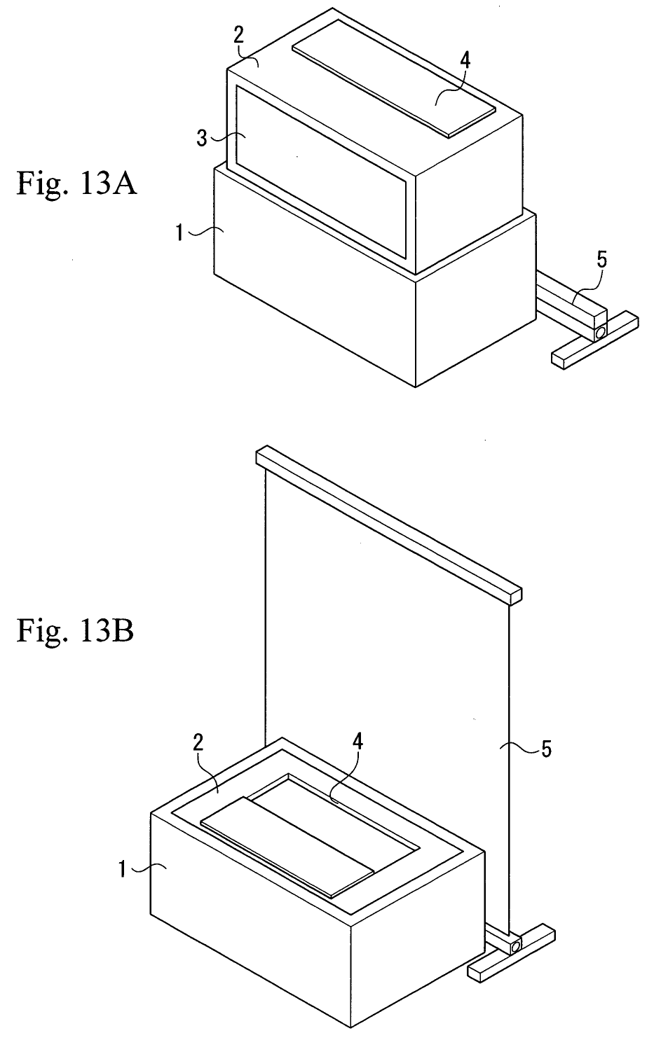

FIGS. 13A and 13B show a third embodiment of the present invention. In the above-described embodiments, the reflection screen 5 is an integral part of the main body of the projection display system. In contrast, in the present embodiment, the reflection screen 5 is separately provided from the main body of the projection display system and is positioned in the vicinity of the main body of the system. Other portions in the structure are similar to those of the above-described embodiments, and explanations thereof are omitted.

In the present embodiment, the reflection screen 5 and the system main body are separate from each other; thus, a desired reflection screen suitable for an audiovisual environment of the user can be selected.

According to the above-described embodiments, one of the rear projection system and the front projection system can be freely selected. Therefore, for example, when movies are to be watched, the front projection system can be selected so as to enjoy impressive images on a big-sized screen. On the other hand, when news or variety programs are to be watched, the rear projection system can be selected so as to easily enjoy the programs without darkening the surroundings.

In addition, an optical path selecting device is provided between the transmission screen and the reflection screen, or the direction in which the head of the projector is arranged is rotated between the transmission screen and the reflection screen. In the rear projection system, the optical path is set front and upward so that light is directed to the transmission screen, and in the front projection system, the optical path is set back and upward so that light is directed to the reflection screen. Accordingly, either images projected onto the transmission screen in the rear projection system and images projected onto the reflection screen in the front projection system can be viewed from the same direction by the audience. Therefore, the audience can enjoy images at the same position in either the rear projection system and the front projection system, and it is unnecessary for the audience to turn round, or unnecessary to change the position of the projection display system.

The above-described projection display systems are preferably applied to television broadcasting, or display of reproduction images of a DVD player.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A projection display system comprising:
a projector for projecting image light;
a reflection screen for displaying images in a front projection system, wherein the light from the projector is emitted to a front face of the reflection screen;
a transmission screen for displaying images in a rear projection system, wherein the light from the projector is emitted to a back face of the reflection screen; and
a selective light projecting device for selectively directing the light from the projector to one of the reflection screen and the transmission screen, so as to perform switching between the front projection system and the rear projection system.

2. The projection display system according to claim 1, wherein the selective light projecting device selectively changes an optical path of the light from the projector between the reflection screen and the transmission screen, so as to direct the light from the projector to one of the reflection screen and the transmission screen.

3. The projection display system according to claim 1, wherein the selective light projecting device selectively rotates a direction of a head of the projector between the reflection screen and the transmission screen, so as to emit the light from the projector to one of the reflection screen and the transmission screen.

4. The projection display system according to claim 1, wherein the reflection screen is attached as an integral part of a main body of the projection display system.

5. The projection display system according to claim 1, wherein the reflection screen is separate from a main body of the projection display system.

6. The projection display system according to claim 1, wherein the reflection screen is bigger than the transmission screen.

7. The projection display system according to claim 1, wherein the switching between the front projection system and the rear projection system is performed using a remote control.

8. The projection display system according to claim 1, wherein when the rear projection system is selected, a control for exposing the transmission screen is performed.

9. The projection display system according to claim 1, wherein when the front projection system is selected, a control for exposing the reflection screen is performed.

10. The projection display system according to claim 1, wherein parameters for focus and zoom of the projector are adjusted in accordance with whether the rear projection system or the front projection system is selected.

11. The projection display system according to claim 10, wherein adjusted values of the parameters for focus and zoom are determined and stored before shipment of the projection display system, and after that the parameters can be freely adjusted and stored.

12. The projection display system according to claim 1, wherein an aspect ratio is switched in accordance with whether the rear projection system or the front projection system is selected.

13. The projection display system according to claim 12, wherein the aspect ratio is set to 4:3 in the rear projection system, and set to 16:9 in the front projection system.

14. The projection display system according to claim 12, wherein each aspect ratio is determined and stored before shipment of the projection display system, and after that the aspect ratio can be freely adjusted and stored.

15. The projection display system according to claim 1, wherein a light output of the projector is adjusted in accordance with whether the rear projection system or the front projection system is selected.

16. The projection display system according to claim 15, wherein adjusted values of each light output are determined and stored before shipment of the projection display system, and after that the light output can be freely adjusted and stored.

17. The projection display system according to claim 15, wherein the adjustment of the light output is performed by selectively using any of lamps having different light outputs.

18. The projection display system according to claim 15, wherein the adjustment of the light output is performed by switching a light output of a single lamp.

19. The projection display system according to claim 15, wherein the adjustment of the light output is performed by mixing light beams from a plurality of lamps.

20. The projection display system according to claim 1, wherein parameters for color and brightness of the projector are adjusted in accordance with whether the rear projection system or the front projection system is selected.

21. The projection display system according to claim 20, wherein adjusted values of the parameters for color and brightness are determined and stored before shipment of the projection display system, and after that the parameters can be freely adjusted and stored.
